(19) United States
(12) Patent Application Publication
(10) Pub. No.: US 2011/0153652 A1
(43) Pub. Date: Jun. 23, 2011

(54) METHOD FOR TRANSMITTING VEHICLE INFORMATION

(75) Inventors: Hyun Jeong Yun, Daejeon (KR); So Yeon Lee, Daejeon (KR); Dong Yong Kwak, Daejeon (KR)

(73) Assignee: Electronics and Telecommunications Research Institute, Daejeon (KR)

(21) Appl. No.: 12/949,463

(22) Filed: Nov. 18, 2010

(30) Foreign Application Priority Data
Dec. 21, 2009 (KR) 10-2009-0128437

(51) Int. Cl. G06F 15/16; G06F 17/30

(52) U.S. Cl. 707/769; 709/217; 707/E17.014

(57) ABSTRACT

A method for a vehicle information collecting device installed in a vehicle to transmit vehicle information includes: generating a vehicle information identifier list including a plurality of vehicle information and a plurality of vehicle information identifiers respectively mapped on the plurality of vehicle information; transmitting the vehicle information identifier list to a terminal; receiving a request for transmitting vehicle information corresponding to at least one vehicle information identifier included the vehicle information identifier list from the terminal; and transmitting vehicle information corresponding to the at least one vehicle information identifier to the terminal based on the vehicle information identifier list.

### CROSS-REFERENCE TO RELATED APPLICATION

This application claims priority to and the benefit of Korean Patent Application No. 10-2009-0128437 filed in the Korean Intellectual Property Office on Dec. 21, 2009, the entire contents of which are incorporated herein by reference.

### BACKGROUND OF THE INVENTION

(a) Field of the Invention

The present invention relates to a method for transmitting vehicle information.

(b) Description of the Related Art

Recently, a Telematics Services in Mobile Terminal for providing a mobile linked entertainment service has attracted attention. The Telematics Services in Mobile Terminal provides a service for alarming a problem of a driving device, a vehicle monitoring service, and a burglary tracking service through a terminal. In addition to the Telematics Services in Mobile Terminal, a door opening/shutting control service, a trunk opening/shutting control service, and an engine-gearshift-cooling water diagnosis service through a terminal-based vehicle remote diagnosis/control service are provided.

For this purpose, a vehicle information collecting device installed in a vehicle collects vehicle information from a vehicle network and transmits the collected vehicle information to the terminal, and the terminal displays the vehicle information. In this instance, vehicle information represents data for indicating a vehicle state, and it includes traveling condition information including vehicle speed, remaining fuel, and vehicle position, vehicle monitoring information, convenience information including control of temperature in the vehicle, seats, and mirror, and entertainment information. Recently, application services have been actively provided by using vehicle information.

A service provider must know vehicle information in order to provide an application service to the vehicle. In this instance, the service provider can know vehicle information from the vehicle information collecting device through the terminal. The vehicle information collecting device drives different programs for respective vehicle models in order to collect vehicle information from a vehicle network. Further, the vehicle information collecting device transmits vehicle information to the terminal based on protocols that are predefined for respective application services. Therefore, when the application service is changed, it is needed to change the vehicle information transmission method between the vehicle information collecting device and the terminal.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for transmitting vehicle information to the terminal irrespective of changes of application services.

An exemplary embodiment of the present invention provides a method for a vehicle information collecting device installed in a vehicle to transmit vehicle information, including: generating a vehicle information identifier list including a plurality of vehicle information and a plurality of vehicle information identifiers respectively mapped on the plurality of vehicle information; transmitting the vehicle information identifier list to a terminal; receiving a request for transmitting vehicle information corresponding to at least one vehicle information identifier included the vehicle information identifier list from the terminal; and transmitting vehicle information corresponding to the at least one vehicle information identifier to the terminal based on the vehicle information identifier list.

Another embodiment of the present invention provides a method for a vehicle information collecting device installed in a vehicle to transmit vehicle information, including: collecting event generation information in the vehicle; searching a vehicle information identifier that corresponds to the event from a vehicle information identifier list including a plurality of vehicle information and a plurality of vehicle information identifiers respectively mapped on the plurality of vehicle information; and transmitting vehicle information including the event generation information to a terminal based on the searched vehicle information identifier.

Yet another embodiment of the present invention provides a method for a terminal to collect vehicle information, including: receiving a vehicle information identifier list including a plurality of vehicle information and a plurality of vehicle information identifiers respectively mapped on the plurality of vehicle information from a vehicle information collecting device installed in a vehicle; requesting the vehicle information collecting device to transmit vehicle information corresponding to at least one vehicle information identifier included in the vehicle information identifier list; and receiving vehicle information corresponding to the at least one vehicle information identifier from the vehicle information collecting device.

### BRIEF DESCRIPTION OF THE DRAWINGS

FIG. 1 shows a vehicle information transmission system according to an exemplary embodiment of the present invention.

FIG. 2 shows a vehicle network according to an exemplary embodiment of the present invention.

FIG. 3 shows a mapping example of a vehicle information set according to an application service in a vehicle information transmission system according to an exemplary embodiment of the present invention.

FIG. 4 and FIG. 5 show a vehicle information transmission method of a vehicle information transmission system according to an exemplary embodiment of the present invention.

FIG. 6 shows an operation method of a vehicle information collecting device when an event occurs in a vehicle according to an exemplary embodiment of the present invention.

FIG. 7 shows a vehicle information identifier list transmission method between a vehicle information collecting device and a terminal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

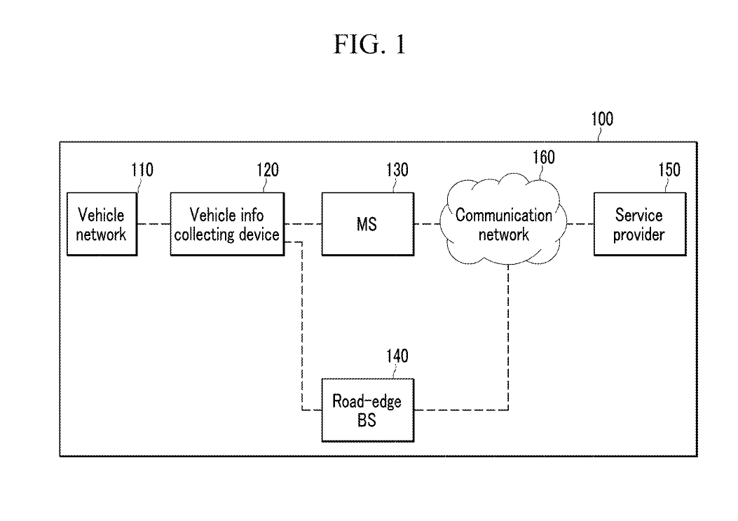

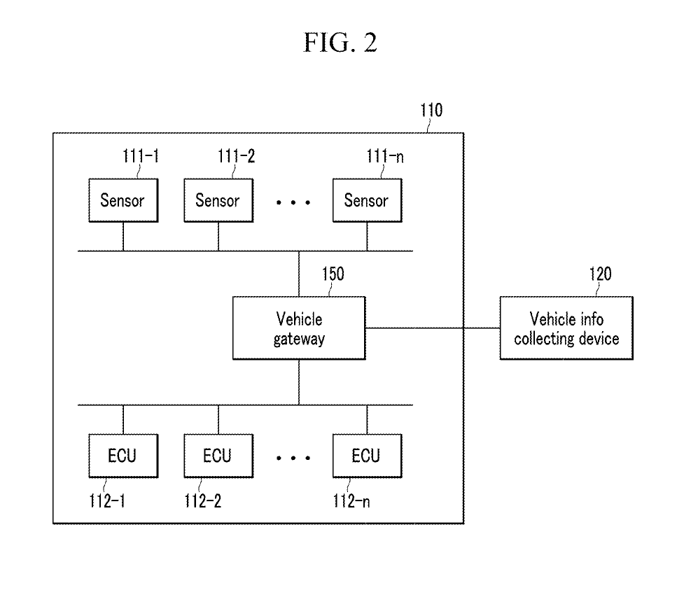

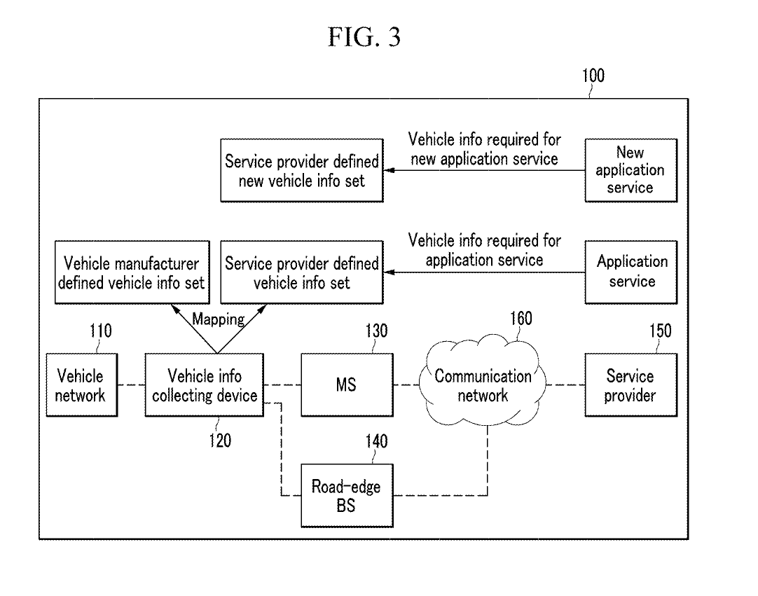

FIG. 1 shows a vehicle information transmission system 100 according to an exemplary embodiment of the present invention, FIG. 2 shows a vehicle network 110 according to an exemplary embodiment of the present invention, and FIG. 3 shows a mapping example of a vehicle information set according to an application service in a vehicle information transmission system 100 according to an exemplary embodiment of the present invention.

Referring to FIG. 1, the vehicle information transmission system 100 includes a vehicle network 110, a vehicle information collecting device 120, a terminal 130, a road-edge base station 140, and a service provider 150.

Referring to FIG. 1 and FIG. 2, the vehicle network 110 is formed in the vehicle, and includes sensors (111-1, 111-2, . . . , 111-n), electronic control units (ECU's) (112-1, 112-2, . . . , 112-n), and a vehicle gateway 113.

The vehicle gateway 113 is connected to the sensors (111-1, 111-2, . . . , 111-n) and the ECU's (112-1, 112-2, . . . , 112-n), and transmits the vehicle information collected from the sensors (111-1, 111-2, . . . , 111-n) and the ECU's (112-1, 112-2, . . . , 112-n) to the vehicle information collecting device 120.

Referring to FIG. 1, for example, the vehicle information collecting device 120 is connected to the vehicle network 110 through an on-board diagnostics (OBD) interface or a controller area network (CAN) interface, and transmits vehicle information collected from the vehicle network 110 to the terminal 130 and/or the road-edge'base station 140.

The terminal 130 is provided inside or outside the vehicle, and receives vehicle information from the vehicle information collecting device 120 through short-distance communication.

The road-edge base station 140 is provided outside the vehicle, and receives vehicle information from the vehicle information collecting device 120 through middle to long distance communication.

The service provider 150 communicates with the terminal 130 and/or the road-edge base station 140 through a communication network 160, and provides an application service based on vehicle information required through communication. For example, the service provider 150 can be an intelligent transportation system (ITS) service provider or a vehicle diagnosis service provider.

Referring to FIG. 3, the vehicle information set including data on the vehicle information is defined for each vehicle manufacturer or service provider. The vehicle information set defined by the vehicle manufacturer (hereinafter, vehicle manufacturer defined vehicle information set) is transmitted from the vehicle network 110 and is stored in the vehicle information collecting device 120. The vehicle information set defined by the service provider 150 (hereinafter, service provider defined vehicle information set) includes vehicle information that is required by the service provider 150 to provide an application service.

The vehicle manufacturer defined vehicle information set and the service provider defined vehicle information set are different in data types and expression forms. For example, regarding vehicle information signifying the engine speed, the data type and expression form of the vehicle manufacturer defined vehicle information set can be different from the data type and expression form of the service provider defined vehicle information set.

Therefore, the vehicle information collecting device 120 maps the relationship of the vehicle manufacturer defined vehicle information set and the service provider defined vehicle information set, and transmits vehicle information to the terminal 130 and/or the road-edge base station 140 based on the mapping. However, when the service provider 150 desires to add a new application service or delete an existing application service, the service provider defined vehicle information set is changed. Accordingly, when the vehicle manufacturer defined vehicle information set supports a new service provider defined vehicle information set, it is needed to change the protocol between the vehicle information collecting device 120 and the terminal 130 or between the vehicle information collecting device 120 and the road-edge base station 140.

For example, a protocol such as the ISO/NP 29284 ITS Event based Probe Vehicle Data, ISO 22837 Vehicle probe data for wide area communications, and SAE J 2735 DSRC Msg. Set Dic is used between the service provider 150 for providing an emergency service and vehicle probe data collecting service and the terminal 130 or the road-edge base station 140. When the service provider 150 tries to further provide a vehicle diagnosis service, a new application service, as well as the emergency service and vehicle probe data collecting service, a new protocol is used between the terminal 130 and the service provider 150 and between the road-edge base station 140 and the service provider 150. The respective protocols define different data formats, expression forms, and message ID's, and the data formats are not mutually referred to between the protocols.

Each time the service provider 150 tries to provide a new application service, the protocol used to transmit vehicle information between the vehicle information collecting device 120 and the terminal 130 or the road-edge base station 140 becomes different, and the vehicle information collecting device 120 and the terminal 130 must change the software program in order to support the changed protocol. A method for a vehicle information collecting device to transmit vehicle information to the terminal or the road-edge base station irrespective of changes of the application service provided by the service provider 150 will now be described.

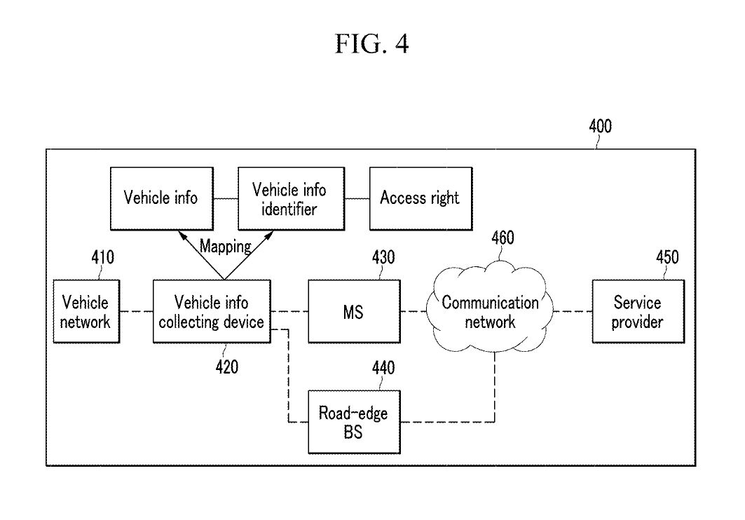

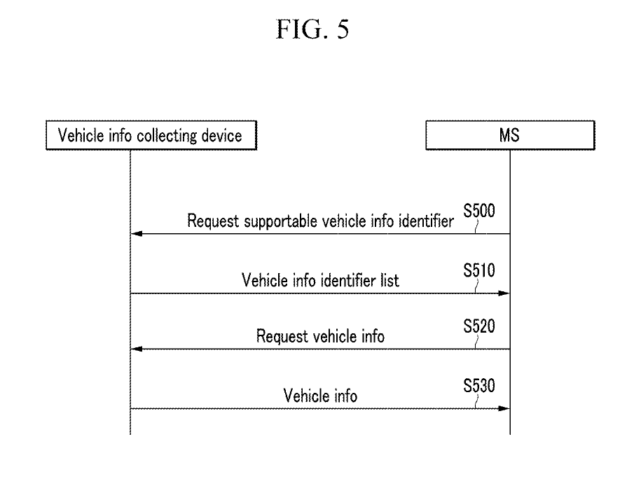

FIG. 4 and FIG. 5 show a vehicle information transmission method of a vehicle Information transmission system 400 according to an exemplary embodiment of the present invention.

Referring to FIG. 4, the vehicle information transmission system 400 includes a vehicle network 410, a vehicle information collecting device 420, a terminal 430, a road-edge base station 440, and a service provider 450. The vehicle information collecting device 420 is connected to the vehicle network 410, and transmits vehicle information collected from the vehicle network 410 to the terminal 430. The method for the vehicle information collecting device 420 to transmit vehicle information to the terminal 430 will now be exemplified, and the vehicle information collecting device 420 can transmit vehicle information to the road-edge base station 440 or transmit the vehicle information directly to the service provider 450.

The vehicle information collecting device 420 stores a vehicle information identifier list. The vehicle information identifier list includes vehicle information supportable by the vehicle and vehicle information identifiers mapped per piece of vehicle information. The vehicle information identifier list can further include access right information for each piece of vehicle information. The service provider 450 communicates with the terminal 430 and/or the road-edge base station 440 through a communication network 460, and provides an application service based on the vehicle information required through communication.

Table 1 shows an example of a vehicle information identifier list stored by the vehicle information collecting device 420.

TABLE 1

| Vehicle | | | | |
|---|---|---|---|---|
| information | Data | | | |
| identifier | factors | Operation | Value | Access right |
| ECU-1/Data | Driver | Lock/ | Lock/ | Driver/Passenger/ |
| Identifier-1 | Door | Unlock/ | Unlock | Diagnostic Tool |
| | | Monitor | | |
| ECU-1/Data | Seatbelt | | Engaged/Not | Driver/Passenger |
| Identifier-2 | | | engaged | |
| ECU-1/Data | Window | Lock/ | | Driver/Passenger/ |
| Identifier-3 | Lock | Unlock/ | | Diagnostic Tool |
| | | Monitor | | |
| ECU-2/Data | Fuel | Monitor | Level | Driver |
| Identifier-1 | | | (Liter) | |
| ECU-3/Data | Engine | Monitor | Level | Driver/Diagnostic |
| Identifier-2 | Oil | | (Liter) | Tool |

Table 1 includes a vehicle information identifier list mapped per piece of vehicle information. The vehicle information identifier includes identification information on a vehicle information collecting vehicle device and identification information on vehicle information including data. For example, the vehicle information identifier is configured by a set of electronic control unit identifiers (ECU-1, ECU-2, ECU-3) and data identifiers (Data Identifier-1, Data Identifier-2, Data Identifier-3).

Further, an access right mode is defined for each vehicle information identifier. The access right mode includes a driver mode, a passenger mode, and a diagnostic tool mode. The access right is defined for each vehicle information identifier based on a characteristic of vehicle information. For example, the access right to vehicle information with a privacy characteristic is allowable to the driver, the access right to vehicle information for vehicle maintenance and entertainment information is allowable to the driver and the passenger, the access right to vehicle diagnosis information is allowable to the service provider 450, and the access right to emergency/safety information is allowable to the driver, the passenger, and the service provider 450.

Referring to FIG. 4 and FIG. 5, the terminal 430 requests a currently supportable vehicle information identifier list from the vehicle information collecting device 420 (S500), and the vehicle information collecting device 420 provides the vehicle information identifier list to the terminal 430 (S510).

The terminal 430 selects a vehicle information identifier from the received vehicle information identifier list and transmits the same to the vehicle information collecting device 420 (S520). The vehicle information collecting device 420 transmits vehicle information that corresponds to the received vehicle information identifier to the terminal 430 (S530).

For example, when the vehicle information collecting device 420 transmits a vehicle information identifier list (ECU-1/Data Identifier-1-_Driver Door, ECU-3/Data Identifier-2_Engine Oil) mapped per piece of vehicle information to the terminal 430 (S510), the terminal 430 selects ECU-1/Data Identifier-1, the vehicle information identifier, and transmits it to the vehicle information collecting device 420 (S520), and the vehicle information collecting device 420 transmits a locked/unlocked state of the door on the driver side together with ECU-1/Data Identifier-1, the vehicle information identifier, to the terminal 430 (S530).

In this instance, the vehicle information collecting device 420 uses the extensible markup language (XML)-based protocol to transmit vehicle information to the terminal 430. Here, the vehicle information collecting device 420 is operable as an information providing server, and the terminal 430 is operable as an information requesting client. Table 2 shows an application example of an XML-based protocol between the vehicle information collecting device 420 and the terminal 430.

TABLE 2

Client request frame
{ function = Exchange: data = requestString }
Server response frame
{ function = Exchange: error = errorValue: data = responseString }
requestString
<VMG_COM_TEL type=“xyz_call”>

<XYZ_CALL longMode=false|true>
...
</XYZ_CALL>

</VMG_COM_TEL>
responseString
<VMG_COM_TEL type=“xyz_reply”>

<XYZ_REPLY longMode= false|true>
...
</XYZ_REPLY>

</VMG_COM_TEL>

Referring to Table 2, the client (i.e., terminal 430) requests data through a requestString. The server (i.e., vehicle information collecting device 420) responds to the client's request through a responseString.

When the vehicle information is transmitted by using the XML-based protocol and the terminal 330 of the driver or the passenger has an XML parser, the vehicle information can be shared when the access right has a restriction.

According to the method exemplified through FIG. 4 and FIG. 5, the vehicle information identifier and the vehicle information are transmitted between the vehicle information collecting device 420 and the terminal 430 by using the XML-based protocol regardless of application service types. Hence, there is no need to change the vehicle information transmission method when the application service is changed. Also, the vehicle information is transmitted between the vehicle information collecting device 420 and the terminal 430 by using the vehicle information identifier. Therefore, the vehicle information is easily and efficiently transmitted irrespective of the application service types.

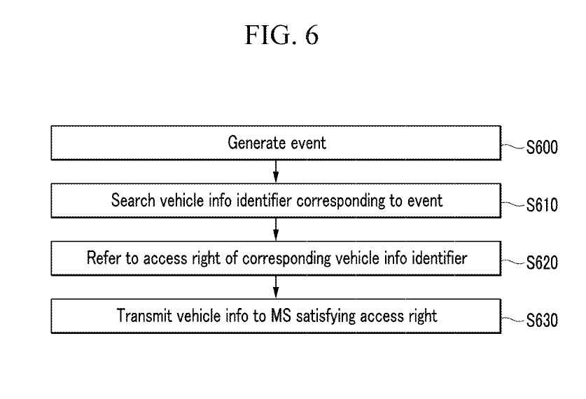

FIG. 6 shows an operation method of a vehicle information collecting device 420 when an event occurs in a vehicle according to an exemplary embodiment of the present invention.

Referring to FIG. 6, when an event is generated in the vehicle (S600), the vehicle information collecting device 420 searches a vehicle information identifier corresponding to the generated event from the vehicle information identifier list (S610). For example, the event includes vehicle door opening, vehicle door closing, and engine oil replacement time notification.

When there is at least one terminal for receiving vehicle information in/near the vehicle, the vehicle information collecting device 420 refers to the access right of the corresponding vehicle information identifier (S620), and transmits vehicle information to the terminal 430 satisfying the access right (S630). For example, when there are a terminal of the driver and a terminal of the passenger in the vehicle and the access right to the corresponding vehicle information identifier is limited to the driver, the vehicle information collecting device 420 transmits vehicle information to the driver's terminal 430.

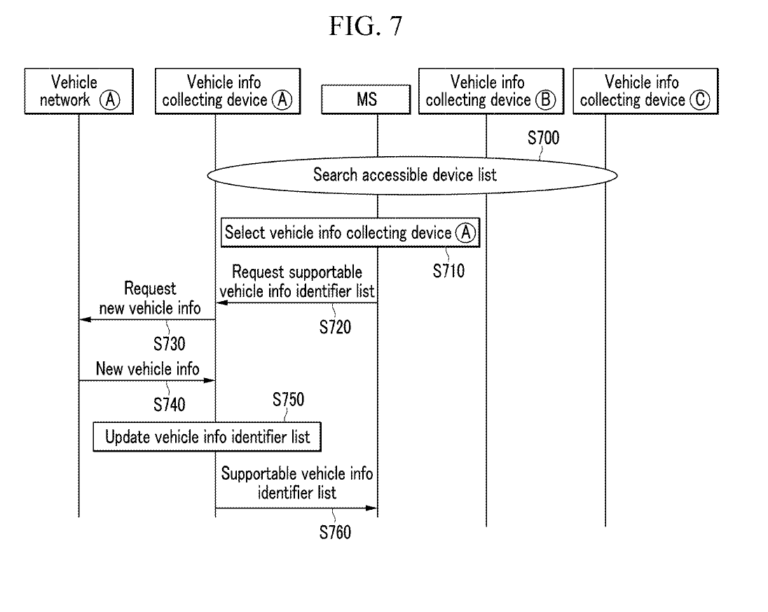

FIG. 7 shows a vehicle information identifier list transmission method between a vehicle information collecting device 420 and a terminal 430 according to an exemplary embodiment of the present invention.

Referring to FIG. 7, the terminal 430 searches an accessible vehicle information collecting device list (S700). For example, when the user stands near vehicle A, vehicle B, and vehicle C and the vehicles A and Care owned by the user, a vehicle information collecting device A (VMG 1) of vehicle A and a vehicle information collecting device C (VMG 3) of vehicle C can be searched for the available vehicle information collecting device 420. Table 3 can be output to the terminal 430.

TABLE 3
Accessible device list

VGM1 (Version 1.10)
Vehicle type: Type A
Vehicle model: Model A
VGM3 (Version 1.20)
Vehicle type: Type C
Vehicle model: Model C

The accessible list of the vehicle information collecting device 420 output to the terminal 430 includes a vehicle type, a vehicle model, and a version of the vehicle information collecting device 420.

When the user desires to know vehicle information on vehicle A, the terminal 430 selects the vehicle information collecting device A from the searched vehicle information collecting device list (S710). In this instance, the user can select the vehicle information collecting device A through the user interface.

The terminal 430 requests a currently supportable vehicle information identifier list from the vehicle information collecting device A (S720). In this instance, the terminal 430 can request the vehicle information identifier list by using the XML-based protocol. Table 4 shows an example of an XML-based protocol used for the terminal 430 to request the vehicle information identifier list.

TABLE 4

Client request frame
{ function = Exchange; data = requestString }
requestString
<VMG_COM_TEL type=“GET_DATA_ID_LIST_CALL”>

<XYZ_CALL longMode=false|true>
...
</XYZ_CALL>

</VMG_COM_TEL>

The vehicle information collecting device A requests vehicle information newly supported by the vehicle A from the vehicle network A (S730), and the vehicle network A transmits the newly supported vehicle information to the vehicle information collecting device A (S740). The vehicle information newly supported by the vehicle A can be known from information newly registered to each ECU of the vehicle network A.

The vehicle information collecting device A updates the vehicle information identifier list based on the vehicle information received from the vehicle network A (S750), and transmits the currently supportable vehicle information identifier list to the terminal 430 (S760). Table 5 shows an example of an XML-based protocol used for the vehicle information collecting device A to transmit the vehicle information identifier list to the terminal 430.

TABLE 5

Server response frame
{ function = Exchange; error = errorValue; data = responseString }
responseString
<VMG_COM_TEL type=“ GET_DATA_ID_LIST_CALL ”>

<XYZ_REPLY longMode=false|true>
...
</XYZ_REPLY>

</VMG_COM_TEL>

Accordingly, Table 6 can be output to the terminal 430.

TABLE 6
Available data (ECU 2)

ECU 2-Data Id 1: fuel
ECU 2-Data Id 2: engine oil
ECU 2-Data Id 3: door state on the driver's side

Upon having received the vehicle information identifier list according to the method exemplified with reference to Table 5 and Table 6, the terminal 430 requests vehicle information that corresponds to the vehicle information identifier from the vehicle information collecting device A. In this instance, the terminal 430 can use the XYZ_CALL longMode.

Vehicle information can be efficiently sent to the terminal. Particularly, when the application service to be provided by the service provider is changed, the vehicle information transmission method is not changed and the vehicle information can be transmitted simply and quickly. Also, it is not needed to update the software program of the terminal each time the application service is changed.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a vehicle information collecting device installed in a vehicle to transmit vehicle information, comprising:
generating a vehicle information identifier list including a plurality of vehicle information and a plurality of vehicle information identifiers respectively mapped on the plurality of vehicle information;
transmitting the vehicle information identifier list to a terminal;
receiving a request for transmitting vehicle information corresponding to at least one vehicle information identifier included the vehicle information identifier list from the terminal; and
transmitting vehicle information corresponding to the at least one vehicle information identifier to the terminal based on the vehicle information identifier list to the terminal.

2. The method of claim 1, wherein
the generating of a vehicle information identifier list includes:
requesting currently supportable new vehicle information from a vehicle network formed in the vehicle;
receiving the new vehicle information from the vehicle network; and
updating the vehicle information identifier list by using the new vehicle information.

3. The method of claim 1, wherein
the vehicle information identifier includes identification information on each vehicle information collecting device and identification information on data of each vehicle information.

4. The method of claim 1, wherein
the vehicle information identifier list further includes information on an access right assigned for each vehicle information identifier.

5. The method of claim 1, wherein
the vehicle information is transmitted by using an extensible markup language (XML)-based protocol.

6. A method for a vehicle information collecting device installed in a vehicle to transmit vehicle information, comprising:
collecting event generation information of the vehicle;
searching a vehicle information identifier that corresponds to the event from a vehicle information identifier list including a plurality of vehicle information and a plurality of vehicle information identifiers respectively mapped on the plurality of vehicle information; and
transmitting vehicle information including the event generation information to a terminal based on the searched vehicle information identifier.

7. The method of claim 6, wherein
the searching of a vehicle information identifier further includes
checking to an access right of the vehicle information identifier, and
the transmitting of vehicle information includes
transmitting the vehicle information to the terminal satisfying the access right.

8. A method for a terminal to collect vehicle information, comprising:
receiving a vehicle information identifier list including a plurality of vehicle information and a plurality of vehicle information identifiers respectively mapped on the plurality of vehicle information from a vehicle information collecting device installed in a vehicle;
requesting the vehicle information collecting device to transmit vehicle information corresponding to at least one vehicle information identifier included in the vehicle information identifier list; and
receiving vehicle information corresponding to the at least one vehicle information identifier from the vehicle information collecting device.

9. The method of claim 8, wherein
the vehicle information identifier includes identification information on each vehicle information collecting device and identification information on data of each vehicle information.

10. The method of claim 8, wherein
the vehicle information identifier list further includes information on an access right assigned to each vehicle information identifier.

11. The method of claim 8, wherein
the requesting to transmit vehicle information and the receiving of vehicle information is performed by using an XML-based protocol.

12. The method of claim 8, wherein further including
searching a vehicle information collecting device accessible by the terminal from among a plurality of vehicle information collecting devices provided near the terminal.
